(19) United States
(12) Patent Application Publication
(10) Pub. No.: US 2025/0000629 A1
(43) Pub. Date: Jan. 2, 2025

(54) PIEZOELECTRIC DRIVE

(71) Applicant: Curaden AG, Kriens (CH)

(72) Inventors: Ueli BREITSCHMID, Meggen (CH); Joshua LANTER, Küssnacht am Rigi (CH)

(21) Appl. No.: 18/705,184

(22) PCT Filed: Oct. 28, 2022
(86) PCT No.: PCT/EP2022/080297

§ 371 Date: Apr. 26, 2024

(30) Foreign Application Priority Data
Oct. 29, 2021 (EP) 21205649.3

(51) Int. Cl. A61C 17/22; A46B 5/00; A46B 13/02; A61C 17/34

(52) U.S. Cl. CPC A61C 17/225; A46B 5/0095; A46B 13/02; A61C 17/3418; A61C 17/3445

(57) ABSTRACT

In a handle for a personal care appliance, a drive unit includes a piezoelectric drive (100) for generating an oscillating movement. The piezoelectric drive includes a piezoelectric element (120) having first and second ends, in which a change in length in an X-direction occurs upon electrical activation, so that a distance between the first and second ends changes. A first end of a spring bracket (110) is affixed to a first end of the piezoelectric element and a second end of the spring bracket is affixed to the second end of the piezoelectric element, whereby the change in length of the piezoelectric element in the X-direction is converted into a first bracket stroke in a Y-direction. A connecting element (130) is configured to transmit the oscillating movement to the personal care device and is attached in a central region of the spring bracket for tapping the first bracket stroke.

### CROSS-REFERENCE

This application is the U.S. National Stage of International Application No. PCT/EP2022/080297 filed on Oct. 28, 2022, which claims priority to European patent application no. 21 205 649.3 filed on Oct. 29, 2021.

### TECHNICAL FIELD

The present invention generally relates to a handle with a drive unit for a personal care appliance, wherein the drive unit comprises a piezoelectric drive for generating a drive (oscillating) movement, comprising a piezoelectric element, whereby a change in length in an X-direction occurs upon electrical activation. The present invention also generally relates to a piezoelectric drive for generating a rotational (oscillating) movement, comprising a piezoelectric element, whereby a change in length in an X-direction occurs when electrically activated.

### BACKGROUND ART

Toothbrushes having a cleaning element that is moved by a motor have been known for a long time. Electric motors, electromagnets and piezoelectric elements, inter alia, have been used as drives. Studies have shown that so-called electric toothbrushes can achieve a significantly better cleaning effect than manual toothbrushes.

There are different types of electrically powered toothbrushes.

The principle of a round brush head, which can rotate around an axis parallel to the bristle direction and is moved back and forth around this axis, is known from the publications DE 10 2016 011477 (Schiffer), EP 2 454 967 A1 (Braun), WO 2005/046508 A1 (Trisa) and others. The advantage of this arrangement is that the moving part (namely the round brush head) is very small. It does not require much drive energy and the forces (torques) that occur tend to be small. The disadvantage of this principle is that the bristle movement depends on the distance to the axis of rotation. The closer the bristles are to the axis of the brush head, the smaller the back and forth movement. The movement pattern is therefore very inhomogeneously distributed across the bristle field.

The principle of pendulum motion is known from the publications JP H04-43127 (Kao), US 2006/168744 A1 (Butler), US 2012/0291212 (Montagnino) and others. In these publications, the brush oscillates about a pendulum axis which is perpendicular to the hand apparatus (drive) and to the attached brush and which intersects the longitudinal axis of extension of the hand apparatus and brush at the point where the brush is coupled to the hand apparatus. The advantage is that the intensity of movement is homogeneously distributed over the entire bristle field, because all the bristles have, in particular, more or less the same distance from the pendulum axis. The disadvantage, however, is that relatively large forces (moments) occur because the mass of the brush head is relatively far away from the pendulum axis.

The principle of housing vibration is known from the publications JP 2012-161368 (Sanion), DE 299 13 406 Ul (Rowenta), U.S. Pat. No. 6,766,548 B1 (Rowenta), WO 2005 046508 A1 (Trisa), WO 2013/104020 A1 (Erskine) and others. A drive in the hand apparatus or in the brush neck generates an undefined vibration that is transmitted to the bristles. The advantage of this design is that one does not have to concern oneself with the technical details of motion transmission. The disadvantage, however, is that the entire housing has to be vibrated and accordingly, more drive energy is required than if only a small part has to be vibrated. In addition, the vibration must not be too strong, as this impairs comfort when holding the hand apparatus. Finally, the effective movements of the bristles are not known and the cleaning effect of this type of undefined and uncontrolled vibration is anything but optimal.

Another principle is known from the publications WO 2012-151259 A1 (Water Pik), EP 2 548 531 B1 (Trisa) and others. In these publications, the hand apparatus has a coupling pin that rotates back and forth about the longitudinal axis. The brush mounted on the coupling pin has a straight neck and a bristle plate at the end, from which the bristles are (extend) transverse to the longitudinal axis of the hand apparatus or the brush neck. The advantage of this geometry is that relatively low forces (moments) occur because the mass (neck, bristle plate) of the brush attachment is relatively close to the longitudinal axis (center of movement). The intensity of movement is also distributed relatively evenly across the bristle field. However, the disadvantage of this principle is that the bristles only carry out a one-dimensional movement (back and forth). On the one hand, the foaming effect for the toothpaste is unsatisfactory and, on the other hand, the advantage of the circular and therefore gentle and efficient movement, which has been taught as being beneficial by specialists in connection with manual toothbrushes for decades, is missing.

DE 40 02 199 A1 shows a toothbrush which is moved by sensing the dimensional change of a piezo crystal with one end of a pendulum rod. Since the pendulum rod can rotate about an axis that is transverse to the rod direction, the brush at the opposite end of the pendulum rod carries out a lateral pendulum movement.

The known drives having piezo elements have the disadvantage that only low forces/torques are executable, so that the amplitude is reduced with increased pressure on the bristle field, which in turn reduces the cleaning performance.

### SUMMARY

It is one non-limiting object of the present teachings to disclosure techniques for improving a handle having a drive unit for a personal care appliance, which comprises a piezoelectric drive for generating a drive movement.

In one non-limiting aspect of the present teachings, the piezoelectric drive may comprise a piezoelectric element that has a first end and a second end, whereby a change in length in an X-direction occurs upon electrical activation so that a distance between the first end and the second end changes. A first spring bracket is attached to the piezoelectric element such that a first end of the spring bracket is fixed to the first end of the piezoelectric element and a second end of the spring bracket is fixed to the second end of the piezoelectric element, and thereby the change in length is converted into a first bracket stroke in a Y-direction. A connecting element, which transmits the drive movement to the personal care device, is attached to a central area of the spring bracket for tapping the first bracket stroke.

This design of the drive unit has the advantage that a particularly high-torque drive is achievable. Furthermore, a robust drive is achieved with a particularly simple design, which comprises few moving parts. The moving parts, in particular the spring bracket, are characterized in that bendings are thereby implemented with small angular changes. Thereby, a rapid material fatigue can be avoided.

Preferably, a redirecting transmission is provided, wherein the change in length of the piezoelectric element is converted by the redirecting transmission into a rotational movement of a rotatable shaft, in particular a shaft for a brush head, wherein the shaft is preferably oriented in the X direction. Preferably, a brush head is thus rotated along (around) a longitudinal axis of the brush head, whereby the brush undergoes a pivoting movement around the longitudinal axis of the brush. In variants, the redirecting transmission can also be omitted. In this case, the brush head can be connected directly to the connecting element, whereby the bracket stroke is transmitted directly into a translatory movement of the brush head.

In a further variant, the brush head can also be rotated about an axis parallel to a cleaning element axis. This axis of rotation can be arranged centrally to a brush, in particular a round brush. In this variant, the brush itself is rotated around a central brush axis. On the other hand, the axis can also be oriented parallel to a cleaning element axis and spaced apart from the brush, whereby the rotation is converted into a pendulum movement of the brush.

In a further variant, the change in length of the piezoelectric element can also be transmitted, preferably directly (see above) or indirectly, into an oscillating longitudinal movement, so that a longitudinal movement of the personal care appliance can be generated by the drive movement. With an indirect transmission of the movement, for example, an amplitude of the movement can be optimized with a suitable redirecting transmission. In this variant, the longitudinal movement is preferably oriented in the Y-direction. Thereby, a brush can be moved forwards and backwards, in particular in the Y-direction. However, it is clear to the skilled person that, e.g., a longitudinal movement in another direction can also be achieved with a suitable redirecting transmission.

In a second non-limiting aspect of the present teachings, the handle includes the drive unit for personal care appliances, in particular cleaning appliances for skin care and dental care. The drive unit comprises a piezoelectric element, whereby a change in length in an X-direction occurs upon electrical activation, and a redirecting transmission, wherein the change in length of the piezoelectric element is converted by the redirecting transmission into a rotational movement of a shaft for a brush head, wherein the shaft is preferably oriented in the X-direction. Preferably, the piezoelectric element also comprises a first and a second end in the present second variant, whereby a change in length occurs in an X-direction upon electrical activation, so that a distance between the first and second end changes. A stroke can be generated by the changing of the distance between the first and second ends.

In a variant of the second aspect, the brush head is coupled coaxially with the piezoelectric element directly in the X-direction such that a change in length of the piezoelectric element in the X-direction leads to the same change in length of the brush head in the X-direction. During operation, a translational oscillation of the brush head is generated thereby.

In a further variant of the second aspect, the brush head comprises a pendulum-supported brush neck, wherein the pendulum-supported neck is set into (driven to undergo) a pendulum motion by the stroke of the piezoelectric element.

In a preferred embodiment, the spring bracket is connected to a rotatable shaft via the connecting element such that the first bracket stroke is converted into a rotational movement of the shaft.

The change in length of the piezoelectric element is preferably converted into a first bracket stroke by a spring bracket. By suitably dimensioning the spring bracket, an ideal transformation of the change in length of the piezoelectric element can thus be converted into a stroke movement. The stroke for rotating the shaft on the one hand and the torque of the shaft on the other hand can be optimized thereby. In contrast to the pendulum motion, the moving mass or a deflection of the mass can be kept low by the rotation of the shaft, whereby an energy-saving drive is provided. Furthermore, a drive that is controllable in particularly fast manner is provided for generating a rotational oscillation, with which in turn precise pulses can be generated (e.g. rectangular pulses, sinusoidal oscillations, etc.). For example, depending on the application of the drive, different oscillational behaviors of the rotational oscillation can be generated. When the drive is used as a toothbrush, for example, different cleaning modes can be provided thereby.

The spring bracket can be realized in different ways. Basically, a spring bracket is characterized by the fact that it forms an arch (e.g. in the form of a bent rod or a bent plate) and that it deforms elastically (i.e. curves more strongly) when force is applied. On the one hand, the properties of the spring bracket can be varied by its geometry (see below) and on the other hand by the choice of material. Preferably, the spring bracket is designed as an arched spring bar or as a curved leaf spring. It is particularly preferred that the spring bracket comprises a U-shaped element. The U-shaped element is preferably connected to the piezoelectric element via the two free ends such that a distance between the free ends of the U-shaped element changes as a result of a change in length of the piezoelectric element in the X-direction. The spring bracket preferably comprises a resilient band-shaped material that has a U-shape.

In a preferred embodiment, the spring bracket is formed from a resilient band-shaped material which has constant cross-sectional dimensions and material composition over the entire length, a particularly cost-effective spring bracket is created thereby. Thus, the spring bracket can be achieved, for example, by cutting the strip-shaped material to length from rolls and then bending it.

In another preferred embodiment, a central area (intermediate region) of the spring bracket has less resilient (elastic) properties than the outer areas. Mounting of the connecting element is simplified thereby. For example, the central area can have a larger material thickness (e.g. a larger cross-section). However, the central area can also have a different material composition or can be influenced by the manufacturing process so that the resilient properties of the central area differ from the outer areas of the spring bracket (thermal treatment, change in cross-section at the outer areas due to material removal, change in cross-section at the outer areas due to rolling processes, etc.).

The piezoelectric drive can be used for different purposes. For example, a toothbrush head can be driven thereby. The brush head can be rotated by the drive unit about an axis, for example about an axis perpendicular and/or parallel to a bristle adapter plate (i.e. an adapter plate to which the filaments of the toothbrush are attached). When rotating about the perpendicular axis, the brush body can be set into a rotational movement in one direction or can also be oscillated. When the brush head is rotated about an axis parallel to the bristle adapter plate, an oscillating movement is preferably generated, wherein the axis is preferably oriented parallel to a brush neck, so that the brush body carries out a pivotal movement or a wiping movement on the teeth. In addition to the typical brush bodies, the brush head can also comprise a so-called U-brush. As the name suggests, the U-brush is formed in a U-shaped manner and has an H-shape in cross-section. The U-brush has bristles within the H-shape. During use, the U-brush is inserted into the mouth like a dental impression and the teeth are guided into the H-shape of the U-brush. The U-Brush is then set in motion or vibrated so that the bristles carry out a movement relative to the teeth and thus clean the teeth. In principle, all the drive units mentioned above or below can also be used for the vibration of a U-brush.

Furthermore, the drive unit can also be used in facial care devices, wherein a care element is set in sonic motion. The device for facial care can, for example, comprise a facial cleanser, a peeling device or the like.

In further aspect of the present teachings, a piezoelectric drive for generating a rotational movement is provided and is characterized by being capable of generating an increased torque.

According to this aspect of the present teachings, the piezoelectric drive may comprise a piezoelectric element, whereby a change in length in an X-direction occurs upon electrical activation, wherein a first spring bracket is preferably attached to the piezoelectric element such that the change in length is converted into a first bracket stroke in a Y-direction. The first spring bracket may be connected to a rotatable shaft via a connecting element such that the first bracket stroke is converted into a rotational movement of the shaft, and such that the shaft has an axis of rotation that lies in a plane parallel to the X-direction, preferably oriented parallel to the X-direction.

In addition to applications in personal care appliances, in particular toothbrushes, this piezoelectric drive can also be used in other applications, in particular in microtechnology, for example in drilling devices for rotating a drill. The drive can also be used to drive a grinding device or the like. The drive can also be used as a microdrive in robotics, for example as a gripper, motion drive, cutting tool, etc. for surgery or the like. The drive can also be used, for example, as a drive for a mechanical clock unit. Further applications, in which the generation of the rotational movement according to the present teachings from a change in length of a piezoelectric element can be used, will be apparent to skilled persons.

The term “rotational movement” is understood herein to mean a pivotal or rotational movement about an axis, in particular about a rotational (pivotal) angle of more than 1°, in particular not more than 5°, preferably more than 2°, in particular not more than 3°. The amplitude (rotational angle) is determined with reference to the resting position or center position of 0°. The rotational or pivotal movement is particularly preferably an oscillating movement, in particular a rotational or pivotal oscillation that has, for example, an amplitude (rotational angle) of 1° to 5°, preferably 2° to 3°. The term “rotational oscillation” is understood herein to be an alternating (oscillating) rotation around an axis of rotation, which is known, for example, in the anchor escapements of pendulum clocks. In the application, for example as a drive for a toothbrush, particularly effective movements of a brush body can thus be achieved for an optimum cleaning effect, wherein, for example, the axis of rotation is oriented parallel to the brush neck of the toothbrush or at a right angle to a bristle field (rotary toothbrush). In variants, however, the angle of rotation may also be less than 5°.

The connecting element transmits the movement of the spring bracket to the shaft. For this purpose, the connecting element preferably is eccentrically connected to the shaft in a fixed or detachable manner. The angle of rotation depends on the stroke of the spring bracket and the distance of a point of engagement of the connecting element to the axis of rotation of the shaft. The stroke of the spring bracket can, for example, correspond to twice the distance of the point of engagement of the connecting element to the axis of rotation of the shaft, whereby a crank drive is achieved in which a continuous rotation of the shaft can be achieved. In a further variant, the stroke can be chosen to be smaller, whereby an oscillating movement of the shaft can be achieved (see below).

Preferably, the change in length of the piezoelectric element in the X-direction, particularly in toothbrush applications, is in a range of 50 to 500 micrometers, particularly preferably between 100 and 300 micrometers, especially preferably between 150 and 250 micrometers. On the one hand, a correspondingly larger bracket stroke can be achieved with a large change in length. On the other hand, the piezoelectric element is also dimensioned larger with a greater change in length, which in turn runs counter to a compact design. It has now been shown that an ideal compromise between size and performance can be achieved with the above ranges of changes in length.

Preferably, the shaft has an axis of rotation that lies in a plane parallel to the x-direction, preferably oriented parallel to the x-direction. The piezoelectric element typically has the largest dimension in the direction of the change in length. Similarly, the shaft typically has the largest dimension in the direction of the shaft axis. Due to the parallel orientation, these two components of the drive unit can be accommodated in a small volume, whereby a particularly compact drive is achieved.

In variants, the shaft and the piezoelectric element can also be arranged differently. In particular when the piezoelectric drive is used in a toothbrush, Z movements of a brush head, for example, can be achieved by arranging connecting element obliquely to the axis of rotation.

Preferably, a second spring bracket is provided on a side of the piezoelectric element that is opposite the first spring bracket. The second bracket stroke of the second spring bracket is preferably oriented in the direction of the first bracket stroke of the first spring bracket. The maximum increase in stroke as the sum of the first bracket stroke and the second bracket stroke is achieved thereby. Furthermore, bending forces on the piezoelectric element can be avoided by attaching the first and second spring brackets on opposite sides of the piezoelectric element. In an embodiment having only one spring bracket, the piezoelectric element is preferably arranged in a fixed position relative to the rotatable shaft, whereas in an embodiment having two opposing, in particular mirror-symmetrically arranged spring brackets, the second spring bracket, or more precisely a region of the second spring bracket, is arranged in a fixed position relative to the rotatable shaft. It is clear to the skilled person that, in the embodiment having only one spring bracket, instead of the piezoelectric element a region of the first spring bracket can also (instead) be arranged in a fixed position relative to the rotatable shaft and the piezoelectric element can be connected to the rotatable shaft via the connecting element, whereby the piezoelectric element itself is moved relative to the rotatable shaft by the change in length of the piezoelectric element via the bracket stroke. In this variant, the spring bracket is connected indirectly (via the piezoelectric element) to the rotatable shaft via the connecting element. However, in the embodiment having only one spring bracket, the spring bracket is preferably connected directly to the connecting element.

In variants, the second spring bracket can also be oriented in a different direction. For example, the direction of the first bracket stroke and the direction of the second bracket stroke can enclose (form) an angle of 90° or an angle of 45°. Multiple strokes in different directions can thereby be achieved with a single piezoelectric element, whereby multiple shafts can be set into a rotational movement with a single piezoelectric element.

In variants, the second spring bracket can also be omitted. In such variants, the piezoelectric element can be fixed transverse to the X-direction, whereby the drive unit can be built simpler and more cost-effectively. The first spring bracket can also be dimensioned such that the desired stroke can be achieved without another spring bracket.

Preferably, the first spring bracket comprises two legs that enclose (are on opposite sides of) a base side, wherein the overall length of the piezoelectric element is greater than the length of the base side. Together with the piezoelectric element, the spring bracket thus preferably has the shape of a trapezoid, particularly preferably an isosceles trapezoid, wherein the base side runs parallel to the piezoelectric element and/or to the X direction.

The stroke height h is calculated as a function of the overall length x of the piezoelectric element and the length c of the base side and the lengths b of the two legs as follows (for an idealized spring bracket having rigid legs and a rigid base side):

$$h ( x ) = \sqrt{{b}^{2} - \frac{{( x - c )}^{2}}{4}}$$

The base side length c is not relevant for the stroke, but is instrumental as the basis for the connection with the connecting element. In principle, the base side can therefore also be omitted.

The first derivation of h results in the following:

$${h}^{′} ( x ) = \frac{x - c}{4 h ( x )}$$

The rate of change is therefore large when h (x) approaches 0. This is the case when x-c approaches 2b or when the length x of the piezoelectric element minus the length c of the base side approaches twice the length b of the two legs from below. A maximum bracket stroke can thus be achieved with the spring bracket in a particularly compact design. Obviously, it is advantageous for a large bracket stroke if the length c of the base side is chosen to be small.

However, if the torque of the rotational movement is to be weighted higher, the two legs can also be selected to be larger.

In principle, the legs do not necessarily have to be straight, but can have other shapes (curved, etc.). Only the pivot points between the legs or the legs and between a leg and the piezoelectric element are relevant. The trapezoidal shape can also be dispensed with. Instead, a curved element or the like can also be provided as the spring bracket.

Preferably, the spring bracket is made of steel. In variants, the spring bracket can also be made of a synthetic material or a composite material.

Preferably, the base side is oriented parallel to the X-direction. With two legs of equal length, a bracket stroke at a right angle to the X direction is achieved. A straight stroke is achieved thereby, which is particularly easily convertable into a rotational movement.

In variants, the base side can also enclose (form) a non-zero angle with respect to the X-direction. More complex movements, for example a Z-movement, can be generated thereby, which can lead to a good cleaning result, particularly when used as a toothbrush.

Preferably, the connecting element comprises a spring. The oscillating behavior can be bolstered by the spring. The spring also has the advantage that forces, which act on the shaft from the outside, can be absorbed by the spring, whereby the drive unit can be protected. Moreover, the oscillations generated by the piezoelectric element can be modulated thereby, whereby a gentler movement (less acceleration) of the brush head can be achieved in the application as a toothbrush.

In variants, the connecting element can also be rigid. Furthermore, the bracket stroke can also be transmitted into a rotational movement of the shaft in another way, for example via a gear/rack connection. Furthermore, the shaft can be biased with a winding spring, whereby the rotation can be achieved solely by a tensile force of the bracket stroke. Thus, a connecting element can also be designed as a flexible and non-clastic element (e.g. a cord). Further possibilities are known to the skilled person.

The spring (i.e. the connecting element) is preferably designed as a spring plate. In the present case, a spring plate is understood to be a band-shaped element that is made of a resilient material, in particular steel or the like. The spring plate does not necessarily have to be flat in the relaxed state, but can also be bent, have a zigzag shape or be shaped in some other way. The spring effect can be adjusted by the shape and choice of material. A particularly simple and cost-effective spring can be provided by the spring plate. In addition, a connection to the shaft via a longitudinal edge can be provided with the spring plate in a simple manner.

In variants, a coil spring, an elastic element or the like can also be used instead of the spring plate.

In the preferred embodiment, the spring plate is curved so that forces can be absorbed well in both directions and oscillations can be transmitted well. In variants, the spring plate can also be straight.

As was noted above, the connecting element preferably comprises a spring, in particular a spring plate. A particularly simple conversion of the bracket stroke into a rotational movement can be achieved thereby. Thus, the shaft drive is particularly robust, as the spring or the spring plate can absorb external impulses without damaging the piezoelectric drive-in such cases, the spring or the spring plate can serve as an energy buffer. The use of a spring also has the advantage that moving parts such as pivot bearings and the like can be omitted. In particular, the spring can be fixedly connected to the shaft (see below). In principle, the spring can be designed as a spiral spring or the like. In variants, the spring can also be omitted. In this case, the spring bracket can also be connected to the shaft via a rigid element—in this case, however, a pivot bearing would typically be provided to connect the rigid element to the shaft.

Preferably, the connecting element, in particular the spring plate, is eccentrically connected to the shaft, preferably fixedly. A particularly simple conversion of the bracket stroke into a rotational movement is achieved thereby. On the one hand, a structurally simple solution is provided and, on the other hand, a particularly robust drive is achieved, especially as no hinges need to be provided. The spring plate is particularly preferably connected directly and fixedly to the shaft. A rotational movement about a relatively large angle can be thereby achieved with a small bracket stroke.

In variants, the shaft can also comprise a radially oriented lever on which the spring or the spring plate engages. The bracket stroke can also be transmitted into a rotational movement of the shaft in another way, for example by a gear/rack connection. Furthermore, the shaft can be biased by a winding spring, whereby the rotation can be achieved solely by a tensile force of the bracket stroke. Thus a connecting element can also be designed as a flexible and non-elastic element (e.g. a cord). Further possibilities are known to the skilled person.

The piezoelectric drive can be used in various fields. In a preferred embodiment, the piezoelectric drive is used in a handle having a drive unit for personal care appliances, in particular cleaning appliances for skin care and dental care. The piezoelectric drive comprises a piezoelectric element configured to undergo a change in length in an X-direction when electrically activated, and a redirecting transmission, wherein the change in length of the piezoelectric element is converted into a rotational movement of a shaft for a brush head by the redirecting transmission. Preferably, the shaft is oriented in the X-direction.

In the preferred embodiment, the piezoelectric drive is formed (disposed) in the handle of the personal care appliance, in particular the cleaning appliance for skin care and dental care, in particular preferably the sonic toothbrush as described above, and comprises a piezoelectric element configured to undergo a change in length in an X-direction when electrically activated, A first spring bracket is attached to the piezoelectric element such that the change in length can be converted into a bracket stroke in a Y-direction, and the first spring bracket is connected to a rotatable shaft via a connecting element such that the bracket stroke is convertable into a rotational movement of the shaft.

In further embodiments, the piezoelectric element can be connected directly eccentrically to the shaft in a simple case, whereby a change in length of the piezoelectric element in the X direction is converted directly into a rotational movement of the shaft. Due to the typically small strokes of piezoelectric elements, the piezoelectric element would have to engage close to the axis of rotation of the shaft in order to be able to carry out a sufficient rotational movement. Furthermore, the piezoelectric element can be eccentrically connected to the shaft via a connecting element. In these cases, the piezoelectric element can be oriented at a right angle to the axis of rotation of the shaft. In further embodiments, the piezoelectric element can also be oriented differently with respect to the shaft. The piezoelectric drive can further comprise a redirecting transmission, whereby the piezoelectric element can be arranged parallel to the shaft. Furthermore, an angular transmission or the like can be provided in order to convert the change in length of the piezoelectric element into a rotation of the shaft. Further possibilities are known to the skilled person.

Preferably, the shaft is connected to a brush neck of a cleaning device, in particular a sonic toothbrush, so that the brush neck carries out the rotational movement around a brush neck axis. The brush neck axis is particularly preferably oriented coaxially to the axis of rotation of the shaft. Thus, the tufts, which are preferably oriented essentially at right angles to the brush neck axis, can be set in a wiping motion, whereby cleaning, in particular tooth cleaning, can be achieved in a particularly optimal manner. In variants, another redirecting transmission can also be provided between the shaft and the brush neck axis. Moreover, a bristle field also can be rotated (pivotally oscillated) around an axis oriented in the direction of the bristles by using the shaft.

Preferably, the handle, in particular the handle for a personal care appliance, in particular preferably for a sonic toothbrush having an oscillation generator, includes a pin for insertion into the adapter of a brush head, wherein in particular an oscillation is transmittable by the pin from the oscillation generator to a cleaning element of the brush head. Preferably, an oscillation around the pin axis or around the X direction is transmittable by the pin to the cleaning element. In variants, an oscillation in (along) the pin axis or in (along) the X direction can also be effected. The piezoelectric drive can also be designed such that the pin carries out a pivotal movement, for example in the X,Y plane. A technically simple and yet particularly efficient oscillation transmission is achieved thereby. The oscillation generator can, for example, be realized with one or more piezo elements or with electromagnets. Particularly preferably, the oscillation generator comprises a piezoelectric drive as described above. It is further preferred that the oscillation is transmitted to the cleaning means exclusively via the pin. In this case, the brush attachment only contacts the pin of the oscillation generator and therefore no other parts of the handle. In particular, during operation of the personal care appliance, especially the sonic toothbrush or personal care appliance, the housing is preferably in contact with the brush attachment exclusively via the pin.

In variants, the brush head can also comprise the pin. Other transmission means for the oscillation are also known to the skilled person. In particular, a bayonet lock or other connection techniques known to the skilled person can be used instead of a pin.

Preferably, the adapter and the pin are designed such that an anti-rotation lock and a fixation in the adapter axis are achievable when the pin is inserted into the adapter. In other words, the adapter and the pin are preferably configured so that, when the pin is inserted into the adapter, they engage each other (i) to prevent rotation of the adapter relative to the pin (i.e. so that the adapter rotates together with the pin) and (ii) to detachably fix the adapter to the pin along the longitudinal axis of the adapter and pin. Thus, the pin and the adapter are not only used to transmit the oscillations, but also to mount the brush head on the oscillation generator. Thus a particularly simple and therefore cost-effective personal care appliance is achieved in turn, in particular a cleaning appliance such as a sonic toothbrush, as no separate fastening means need be provided.

In variants, an anti-rotation lock can also be achieved by appropriately designing an outer contour of the brush head in the area of the adapter. For this purpose, the outer contour can be accommodated in a correspondingly shaped recess in a housing of the oscillation generator. Furthermore, the brush head can also be connected to the housing via a screw cap having a locking mechanism.

Preferably, the fixation in (along) the adapter axis is formed (implemented) by at least one latching lug of the adapter, which is latchable in a groove of the pin. A particularly simple axial fixing of the brush head to the pin is achieved thereby. For this purpose, the latching lug(s) can be formed, for example, on the inner side of a laterally slotted sleeve.

Alternatively, the brush head can also be latchable onto a housing of the oscillation generator via a latching lug. Furthermore, a frictional connection can also be provided instead of the latching lug in order to achieve a fixation in the adapter axis. However, the frictional connection should be designed such that the brush head cannot detach from the pin when the personal care appliance, in particular the sonic toothbrush, is in operation.

Preferably, the anti-rotation lock may be formed by a lateral flattened portion of the pin and by a corresponding (complementary) shape of the adapter. A particularly simple and cost-effective attachment of the brush head to the pin also is achieved thereby.

In variants, the anti-rotation lock can also be achieved (provided) between the brush head and a housing of the oscillation generator.

Preferably, the flattened portion is provided at (along) the distal end of the pin, adjacent to the groove.

In variants, a flattened portion can also be formed in a central area to the side of the pin. The flattened portion could thereby serve both as an anti-rotation lock and as a receptacle for a latching lug.

Preferably, the rotational movement of the shaft is an oscillating movement having an oscillation frequency between 100 Hertz and 500 Hertz, preferably between 180 Hertz and 300 Hertz. A particularly efficient cleaning is achieved thereby. Alternatively, the oscillation frequency can also be less than 100 Hertz or greater than 500 Hertz. The ideal oscillation frequency depends, inter alia, on the distance of the end of the cleaning element from the axis of rotation and thus on the length of the cleaning element, on a bend angle of the brush neck, etc.

In a preferred embodiment, a switch is provided on the handle, which generates a linear oscillating movement in the X direction of the shaft (longitudinal direction of the brush). Thus, a translational movement in the X-axis can be achieved in addition to the wiping movement of the brush head, which runs in the direction of the Y-axis (i.e. transverse to the X-axis). By superimposing the two movements, a circular movement can be achieved, as is recommended by renowned dentists. In variants, the switch can be omitted. The handle can also be designed such that a permanent superpositioning (combining) of the rotational oscillation with the translational oscillation is effected. The circular movement can also be achieved in other ways, for example by a suitable unbalance in the piezoelectric drive or by an asymmetrical coupling of the connecting element to the rotatable shaft or by providing a bend in the brush neck.

In a preferred embodiment, a personal care appliance, in particular a sonic toothbrush, comprises such a handle and a brush head.

Preferably, the shaft comprises a pin segment for insertion into an adapter of the brush head, wherein oscillations of the shaft can be transmitted to a cleaning element of the brush head by the pin segment, in particular exclusively by the pin segment. As a result, the brush head can be set into an oscillation in a deliberate manner, whereby a particularly energy-efficient sonic toothbrush can be achieved for carrying out particularly effective cleaning, in particular tooth cleaning.

Preferably, the brush head comprises a brush neck, wherein the brush neck comprises a cleaning element having an orientation axis in a distal area, in particular multiple filaments, preferably for cleaning teeth; and
a. in a proximal region, an adapter having an adapter axis for coupling of the brush head to an oscillation generator and for transmitting oscillations from the oscillation generator to the cleaning element; and wherein
b. the adapter axis encloses (forms) an angle with the orientation axis that is greater than 90°, preferably an angle of 91° to 120°, more preferably an angle of 95° to 105°, particularly preferably an angle of 98° to 102°.

A personal care appliance, in particular a sonic toothbrush, with which particularly efficient cleaning, especially of the teeth, can be achieved thereby.

The bend in the direction of the cleaning element (i.e. towards the front) enables a better accessibility, especially on the inner side of the lower front teeth. Furthermore, the cleaning element, or rather the filaments, laterally oscillates, so that a significantly better cleaning can be achieved, especially in the lower jaw. Measured at the bristles, a greater amplitude is also achieved so that cleaning can be carried out with larger movements within the oscillation movement. If the bend points in the opposite direction (rearwards), it in turn enables an optimal cleaning in the interdental spaces. The above-mentioned effects also occur in this design.

Obviously, the oscillations are optimally transmitted by the angled cleaning element such that an improved cleaning effect can be achieved with the sonic toothbrush. By selecting an angle between the adapter axis and the orientation axis that is greater than 90°, preferably between 91° to 120°, further preferably between 95° to 105°, particularly preferably between 98° to 102°, it is also achieved that the brush head can be set in a circular motion, in particular driven by the piezoelectric drive. A particularly ideal cleaning of teeth is achieved thereby. The circular movement has been known for decades to be particularly effective and is recommended by numerous well-known dentists.

It has also been shown in a large number of experiments that the optimum angle between the orientation axis and the adapter axis encloses (forms) an angle of 91° to 120°, preferably an angle of 95° to 105°, particularly preferably an angle of 98° to 102°. This angle is typically, but not necessarily, also present as a bend in the brush neck.

The orientation axis is to be understood herein as the axis of the cleaning element. In a conventional toothbrush, this refers to the axis of a filament. In the case of several filaments, which are arranged, e.g., on a curved surface, the orientation axis is understood to be an average value of the individual axes. On the other hand, in the case of a single bristle for cleaning the interdental spaces, the orientation axis can also be described as a filament direction to which the filaments are attached all around.

The cleaning element can have an angle of 91° to 120° as well as a complementary angle of 60° to 89°. Whether the cleaning element is bent forwards (angle less than) 90° or rearwards (angle greater than) 90° depends on the type of cleaning element. If, for example, a brush head having several filament tufts is used, then the bend preferably has an angle of less than 90°—the cleaning element is thus bent inwards towards the brush neck, which is ideal for reaching the inner side of the lower front teeth.

However, if a single filament tuft is used, for example to clean the interdental spaces, the bend preferably has an angle greater than 90°, whereby the cleaning element is bent rearwards, away from the brush neck. This arrangement is particularly ergonomic for cleaning along the contour of the tooth necks or gums. The cleaning element is therefore preferably arranged on a side of the second segment opposite the enclosed angle. Thus the bend points rearwards so that the cleaning element points away from the first segment.

Preferably, the brush neck includes a first segment comprising the adapter and a second segment comprising the cleaning element, wherein a first main axis of the first segment and a second main axis of the second segment enclose (form) an angle of 150° to 179°, preferably an angle of 165° to 175°, particularly preferably an angle of 169° to 171°.

In variants, the brush neck can also have a different shape which does not directly reflect the line of action of the adapter. A large number of such shapes are known to the skilled person.

In a particularly preferred embodiment, the second main axis and the orientation axis are oriented at a right angle to each other. In variants, however, other orientations between the two axes may also be present.

Preferably, the cleaning element comprises several filament tufts, wherein outer filament tufts project beyond inner filament tufts. The cleaning element thus preferably has a concave surface. It has been shown in tests that a particularly good cleaning effect can be achieved thereby.

In variants, however, other arrangements of the filament tufts can also be provided. In particular, exactly one filament tuft can also be provided, which does not necessarily have a concave surface.

Further advantageous embodiments and combinations of features of the invention result from the following detailed description and the entirety of the patent claims.

### BRIEF DESCRIPTION OF THE DRAWINGS

The drawings used to illustrate the embodiments show:

FIG. 1a a schematic depiction of a side view of a piezoelectric drive in a de-energized state:

FIG. 1b a schematic depiction of a sectional view along line A-A of FIG. 1a:

FIG. 2a a schematic depiction of a side view of a piezoelectric drive with voltage applied:

FIG. 2b a schematic depiction of a sectional view along line A-A of FIG. 2a; and

FIG. 3 a schematic depiction of a side view of a sonic toothbrush comprising a drive.

FIG. 4 a schematic depiction of the first embodiment in the direction of the longitudinal direction on the adapter:

FIG. 5 a schematic depiction of a cross-section along a longitudinal axis through the adapter:

FIG. 6a a schematic depiction of the vibration generator with the pin in a side view:

FIG. 6b a depiction according to FIG. 6a rotated by an angle of 90° around a longitudinal axis:

FIG. 7a a schematic depiction of a side view of a personal care appliance:

FIG. 7b a schematic plan view of a personal care appliance according to FIG. 7a:

FIG. 8a a schematic depiction of a side view of a personal care appliance with a translationally oscillating brush head at a first reversal point of the oscillation:

FIG. 8b a depiction according to FIG. 8a at a second reversal point of the oscillation:

FIG. 9a a schematic depiction of a side view of a personal care appliance with an oscillating brush head at a first reversal point of the oscillation:

FIG. 9b a depiction according to FIG. 9a at a second reversal point of the oscillation:

FIG. 10a a schematic depiction of a side view of a personal care appliance with a rotating brush body at a first reversal point of the oscillation:

FIG. 10b a depiction according to FIG. 10a at a second reversal point of the oscillation:

FIG. 11a a schematic side view of a piezoelectric drive in essence as shown in FIG. 1a, but without a spring bracket in a de-energized state:

FIG. 11b a schematic depiction of a sectional view along line A-A of FIG. 11a:

FIG. 12a a schematic depiction of a side view of a personal care appliance according to FIG. 8a, wherein a U-brush is provided instead of the bristle body; and

FIG. 12b a depiction according to FIG. 12a at a second reversal point of the oscillation. In principle, identical parts are marked with the same reference symbols in the figures.

### DETAILED DESCRIPTION

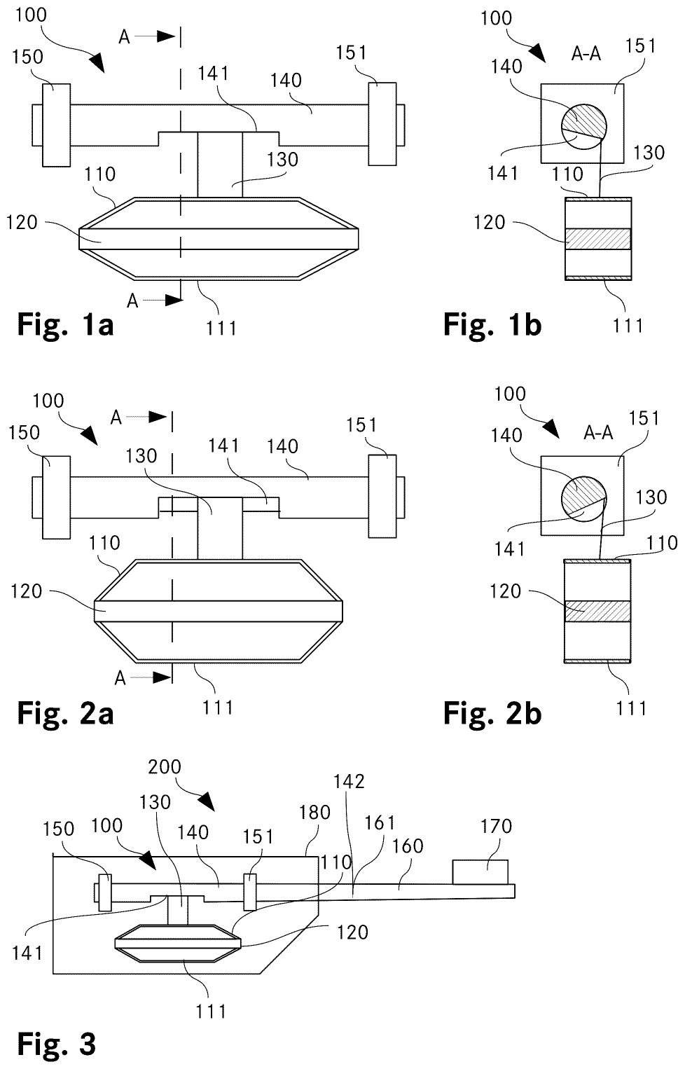

FIG. 1a shows a schematic side depiction of a piezoelectric drive 100 in a de-energized state. The piezoelectric drive 100 comprises a piezoelectric element 120, and spring brackets 110 and 111, respectively, disposed on two opposite sides of the piezoelectric element 120. The spring bracket 110 and the spring bracket 111 together with the piezoelectric element 120 form a trapezoidal shape. The spring brackets 110 and 111 each comprise two legs and a base side (base, intermediate portion/segment) made of a bent metal sheet. The piezoelectric element 120 is accommodated (held) between the legs and has a greater length than the base side of the spring brackets 110 and 111. Thus, the piezoelectric element 120 forms the longest side (dimension) of the trapezoid formed by the piezoelectric element 120 and the spring brackets 110 and 111, respectively. The piezoelectric element 120 is oriented parallel to the base sides of the two spring brackets 110 and 111.

When the piezoelectric element 120 is energized, the length in the X-direction between the two legs of the spring bracket 110 and 111, respectively, changes. Thereby, the distance between the base side(s) and the piezoelectric element 120 in the Y-direction simultaneously changes. This change in distance in the Y-direction will be referred to herein as the “bracket stroke”. Since two spring brackets 110 and 111 are provided in the present embodiment, a double bracket stroke between the two base sides of the spring brackets 110 and 111 is achieved by energizing the piezoelectric element 120. Furthermore, the arrangement of two spring brackets 110 and 111 on opposite sides of the piezoelectric element 120 will reduce bending forces and thus will protect the piezoelectric element.

A shaft 140, which is rotatably supported in two spaced-apart shaft bearings 150 and 151, is arranged parallel to the piezoelectric element 120: the rotational (longitudinal) axis of the shaft 140 extends in the X-direction. A central area of the shaft 140 has a cutout 141, which has the shape of a segment of a circle in the cross-section of the shaft 140. In the present case, the height of the circular segment is less than the radius of the shaft 140—in other embodiments, however, the height can also be equal to or greater than the radius of the shaft 140.

The base side of the spring bracket 110 is connected to the cutout 141 of the shaft via a connecting element formed as a spring plate 130. A plane of the spring plate 130 runs (extends) parallel to the axis of rotation of the shaft 140. The spring plate 130 is connected to the shaft 140 eccentrically, i.e. in the present case in (at) the edge region of the cut-out 141 (see below, FIG. 1b). When the length of the piezoelectric element 120 changes, a bracket stroke is now generated by the two spring brackets 110 and 111, whereby the shaft 140 is set into a rotational movement via the spring plate 130.

FIG. 1b shows a schematic depiction of a sectional view along line A-A of FIG. 1a. It can also be seen therein that the spring plate 130 engages in the edge region of the cutout 141 of the shaft 140 and can thus set the shaft 140 into a rotational movement during a stroke movement of the spring brackets 110 and 111.

FIG. 2a shows a schematic depiction of a side view of the piezoelectric drive according to FIG. 1a, with a voltage applied. In contrast to FIG. 1a, the piezoelectric element 120 is now shortened in an X-direction parallel to the axis of rotation of the shaft 140. The distance between the two base sides of the spring brackets 110 and 111 is thereby increased, whereby in turn the spring plate 130 is moved in the direction of the shaft 140 and thus the shaft 140 is set in a rotational movement. In the present case, the base side of the spring bracket 111 is fixedly disposed relative to the shaft 140.

FIG. 2b shows a schematic depiction of a sectional view along line A-A of FIG. 2a and, compared to FIG. 1b, shows the rotation of the shaft 140 due to the bracket stroke of the two spring brackets 110 and 111.

The piezoelectric drive 100 can be used for a wide range of applications. In a preferred application, the drive is used in an electric toothbrush, preferably in a sonic toothbrush. FIG. 3 shows a schematic depiction of a side view of a sonic toothbrush 200 comprising a piezoelectric drive 100 as shown in FIG. 1a. On the side of the bearing 151 opposite the bearing 150, the shaft 140 comprises an adapter 142, to which a brush neck 160 can be fixed via a counterpart 161 matching the adapter 142 so as to rotate therewith. At a proximal region, the brush neck 160 comprises a bristle field 170. If the piezoelectric element 120 is now alternately energized with a voltage, the two spring brackets 110 and 111 will oscillate, whereby in turn the shaft 140 is set into a rotating oscillation via the spring plate 130. This is transmitted from the shaft 140 to the brush neck 160, which finally sets the bristle field 170 into an oscillating or wiping movement around the brush neck axis.

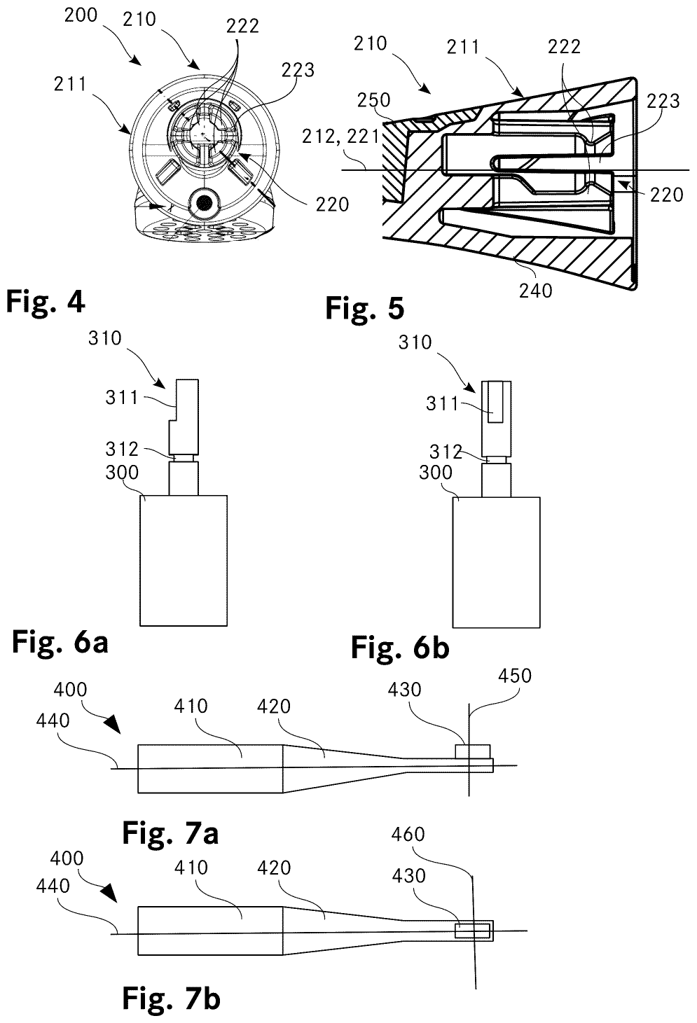

FIG. 4 shows a schematic depiction of an embodiment of a brush neck 210 in the longitudinal direction as a plan view of the adapter. It can be seen here that the adapter 220 is formed, in essence, circular cylindrically. The adapter 220 comprises four latching lugs 222, each of which is interrupted by a slot 223.

FIG. 5 shows the adapter 220 as a schematic depiction of a cross-section along a longitudinal axis.

The adapter 220 serves to accommodate a pin 310 having a flattened portion 311 and a groove 312 (see FIGS. 6a, 6b). For this purpose, the adapter 220 has, in essence, a circular cylindrical receptacle, which comprises a lateral flattened portion in the receptacle base as well as latching lugs 222. The receptacle has, in essence, the shape of a cylindrical shell, which has at least one lateral slot 223 and inwardly projecting latching lugs 223 in the opening direction. Due to the slot 223, the receptacle in the edge area and thus the latching lug 223 is designed in a resiliently flexible manner. The lateral flattened portion in the receptacle base serves to accommodate the laterally flattened end region of the pin 310. Finally, the adapter 220 is designed such that the pin 310 can also be held by frictional engagement, so that oscillation transmission is not impaired.

FIG. 6a shows a schematic depiction of a piezoelectric drive 300 having the pin 310 in a side view. Finally, FIG. 6b shows a depiction according to FIG. 6a, but rotated by an angle of 90° about a longitudinal axis.

The piezoelectric drive 300 transmits the oscillation to the pin 310, which is fixedly connected to the piezoelectric drive 300. The brush head 200 is preferably connected to the piezoelectric drive 300 only via this pin 310. In a distal region, the pin 310 has a flattened portion 311. Further, the pin 310 has a groove 312 for receiving the latching lugs 222. The pin 310 and the adapter 220 are designed such that the pin 310 can be held by the flattened portion 311 in a rotationally fixed manner and can be held axially by the groove 312 and the latching lug 222, respectively. Furthermore, the pin 310 can also be additionally held in the adapter 220 by a frictional connection, so that oscillation transmission is not impaired.

The piezoelectric drive 300 is shown schematically in the present case. Typically, this is installed in a housing which can be ergonomically gripped by the user and which can include further components such as an accumulator (battery), a power supply unit, control units, displays for the user, etc.

FIG. 7a shows a schematic side view of a personal care appliance. The personal care appliance is in the present case designed as a personal care appliance 400 having a handle 410 and a brush attachment 420 with a brush 430, which is interchangeable in the present case. A piezoelectric drive (not shown) is disposed in the handle 410, which generates a rotational oscillation about the X-axis 440, which is transmitted to the brush attachment 420. Thus, the brush attachment 420 carries out a rotational oscillation about the X-axis 440 relative to the handle 410 during operation. Due to the unbalance generated by the bristle field 430, a component of movement in the Y-direction 450 and/or in the Z-direction 460 (see below, FIG. 7b) can be achieved. This effect can be achieved, for example, by providing a bend in the brush neck or by another suitable mass distribution (e.g. also by attaching weights or the deliberate introduction of hollow spaces). FIG. 7b shows a schematic plan view of a personal care appliance as shown in FIG. 7a. The Z-direction 460 can be seen in this depiction.

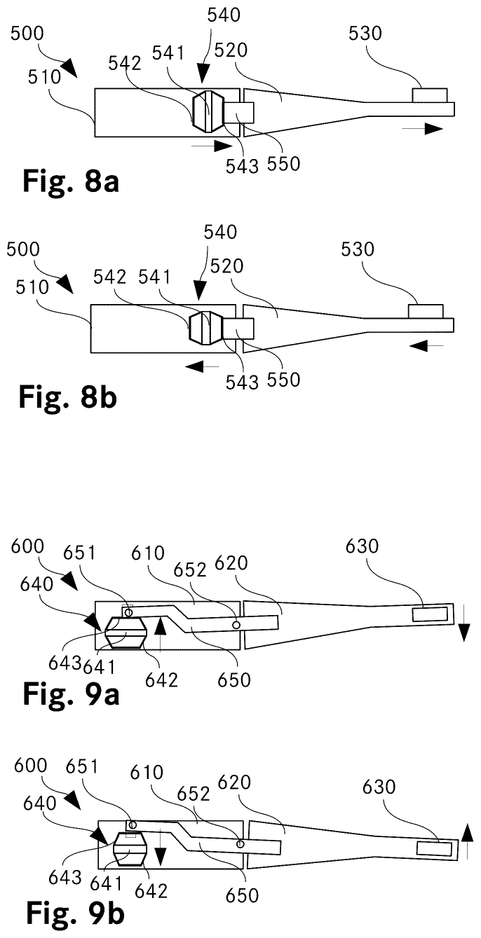

FIG. 8a shows a schematic depiction of a side view of a personal care appliance 500 with a translationally oscillating brush head 520 at a first reversal point of the oscillation. The personal care appliance 500 is designed as a toothbrush and comprises a handle 510 and a brush neck 520 with a cleaning body 530. A piezoelectric drive 540, which comprises a piezoelectric element 541 and a spring bracket 542, 543 on two opposite sides (see also FIG. 1), is disposed in the handle 510. The first spring bracket 542 is fixedly connected to the handle 510, while the second spring bracket 543 is connected to the brush neck 520 via a connecting element 550. The brush neck 520 comprises a receptacle so that the brush neck 520 can be detachably attached to the connecting element 550. The transmission of pivotal oscillations from the handle 510 to the brush neck 520 is effected exclusively via the connecting element 550.

When the piezoelectric element 541 is electrically activated, a change in length of the piezoelectric element 541 occurs, whereby a bracket stroke of the spring brackets 542 and 543 is generated in the X-direction or longitudinal direction of the personal care appliance 500. This in turn leads to a displacement of the connecting element 550 and thus of the brush neck 520 with the brush body 530 in the X-direction. In FIG. 8a, the piezoelectric element 541 is not activated: the brush neck 520 with the brush body 530 is at a first reversal point of the oscillation carried out by the brush neck 520/brush body 530 relative to the handle during operation, in which the brush neck 520 assumes (is located at) the smallest distance from the handle 510. FIG. 8b shows a depiction according to FIG. 8a at a second reversal point of this oscillation, in which the brush neck 520 assumes (is located at) the greatest distance from the handle 510.

FIG. 9a shows a schematic depiction of a side view of another personal care appliance 600 with an oscillating brush head at a first reversal point of the oscillation. The personal care appliance 600 is designed as a toothbrush and comprises a handle 610 and a brush neck 620 with a cleaning body 630. A piezoelectric drive 640, which is designed in an analogous manner to the piezoelectric drive 540 shown in FIG. 8a, is disposed in the handle 610. This comprises a piezoelectric element 641 and spring brackets 642, 643 on the two opposite sides thereof. The first spring bracket 642 is fixedly connected to the handle, while the second spring bracket 643 is connected to a lever 650 via a connecting element via a first pivot bearing 651. The lever 650 is in turn pivotably supported at a pivot bearing 652 that is fixedly disposed relative to the handle 610. With respect to the second pivot bearing 652, the lever 650 is detachably connected to (plugged onto) the brush neck 620 on one side and connected to the connecting element of the piezoelectric drive 640 on the opposite side via the first pivot bearing 651. The transmission of oscillations from the handle 610 to the brush neck 620 is effected exclusively via the connecting element 650.

When the piezoelectric element 641 is activated, a bracket stroke in the Y direction or transversely to the longitudinal direction of the personal care appliance 600 is generated by the spring brackets 642 and 643. This in turn leads to a deflection of the lever 650 around the fixed pivot point 652 of the pivot bearing 652. Thus, the brush neck 620 carries out (undergoes) a wiping movement. In FIG. 9a, the piezoelectric element 641 is not activated: the brush neck 620 with the brush body 630 is at a first reversal point of the oscillation carried out by the brush neck 620/brush body 630 relative to the handle during operation, in which the brush neck 620 is pivoted to the left as seen from above. FIG. 9b shows a depiction according to FIG. 9a at a second reversal point of this oscillation, in which the brush neck 620 is pivoted to the right when viewed from above.

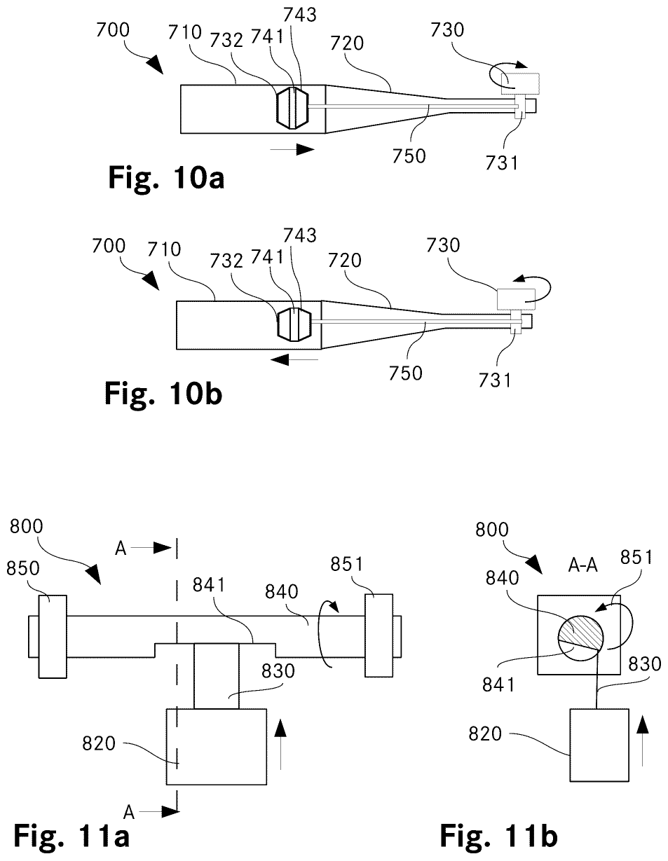

FIG. 10a shows a schematic depiction of a side view of another personal care appliance 700 with a rotating brush body 730 at a first reversal point of the oscillation. The personal care appliance 700 is designed as a toothbrush and comprises a handle 710 and a brush neck 720 with a cleaning body 730. A piezoelectric drive 740, which is designed in an analogous manner to the piezoelectric drive 540 shown in FIG. 8a, is disposed in the handle 710. This comprises a piezoelectric element 741 and spring brackets 742, 743 on the two opposite sides thereof. The first spring bracket 742 is fixedly connected to the handle, while the second spring bracket 743 is connected via a connecting element 750 to a shaft 731 that is oriented in the Y-direction at the distal end of the brush neck 720. The connecting element 750 is eccentrically connected to the shaft, so that a movement of the connecting element 750 in the X-direction leads to a rotation of the shaft 731. In the present case, the brush neck 720 is connected directly to the housing of the handle 710 by known means-however, the brush neck 720 is not connected to the connecting element 750, so that the connecting element can move relative to the brush neck 720 in the X-direction or longitudinal direction. An existing circular brush body 730 is connected to the rotatable shaft 731.

When the piezoelectric element 741 is activated, a bracket stroke in the X-direction or in the longitudinal direction of the personal care appliance 700 is generated by the spring brackets 742 and 743. This in turn leads to a movement of the connecting element 750 in the X-direction, whereby a rotational movement is carried out due to the eccentric attachment of the connecting element 750 to the shaft 731. This in turn leads to a rotation (pivotal oscillation) of the brush body 730. In FIG. 10a, the piezoelectric element 741 is not activated, whereby the shaft 731 is located at a first reversal point of the rotational oscillation when viewed clockwise from above onto the brush body 730, after which a counterclockwise rotation follows. Accordingly, FIG. 10b shows a depiction according to FIG. 10a at a second reversal point of this oscillation, wherein the brush body 730 is located at a counterclockwise rotational stop when viewed from above.

FIG. 11a shows a schematic depiction of a side view of a piezoelectric drive, in essence, as shown in FIG. 1a, but without a spring bracket in a de-energized state. The piezoelectric drive comprises a piezoelectric element 820, which changes its length in the Y-direction when activated (in the exemplary embodiment of FIG. 1, the length changes in the X-direction, and the spring brackets in turn generate the bracket stroke in the Y-direction).

A shaft 840, which is rotatably mounted in two spaced-apart shaft bearings 850 and 851, is arranged parallel to the piezoelectric element 820. The shaft 840 has-analogous to the embodiment of FIG. 1—a cutout 841 in a central region.

The piezoelectric element is connected to the cutout 841 of the shaft via a spring plate 830. The spring plate 830 is eccentrically connected to the shaft 840 in the edge region of the cutout 841. When the length of the piezoelectric element 820 changes, a stroke is now generated, whereby the shaft 840 is set in a rotational movement via the spring plate 830.

FIG. 11b shows a schematic depiction of a sectional view along line A-A of FIG. 11a. It is apparent therein that the spring plate 830 engages in the edge region of the cut-out 841 of the shaft 840 and can thus set the shaft 840 into a rotational movement during a stroke movement of the piezoelectric element 820.

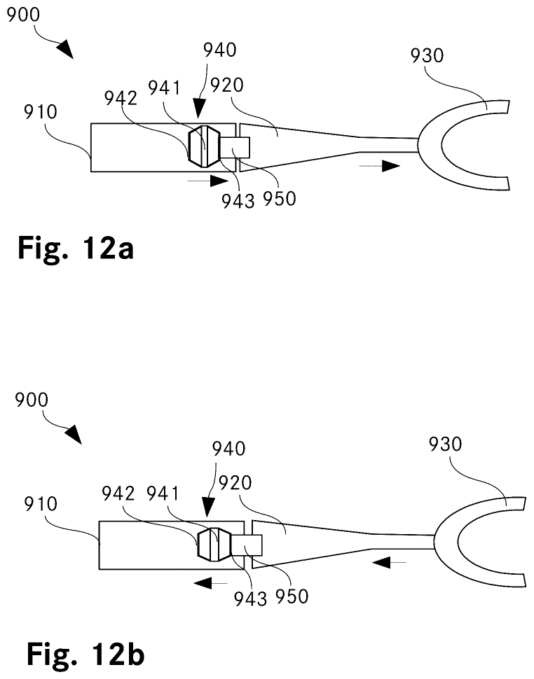

FIG. 12a shows a schematic side view of a personal care appliance as shown in FIG. 8a, wherein a U-brush 930 is provided instead of the bristle body. A U-brush 930 is a U-shaped brush which has an H-shaped cross-section with bristles on the inside so that the teeth of the upper or lower jaw can be positioned in the opposing grooves. By vibrating the U-Brush 930, all teeth can be cleaned simultaneously.

The personal care appliance 900 is thus designed as a toothbrush and comprises a handle 910 and a brush neck 920, wherein the U-brush is attached to a distal end of the brush neck 920. The opening of the U-shape of the U-brush 930 projects away from the brush neck 920. A piezoelectric drive 940, which comprises a piezoelectric element 941 and spring brackets 942, 943 on the two opposite sides thereof (see also FIG. 1), is disposed in the handle 910. The first spring bracket 942 is fixedly connected to the handle 910, while the second spring bracket 943 is connected to the brush neck 920 via a connecting element 950. The brush neck 920 comprises a receptacle so that the brush neck 920 can be detachably attached to the connecting element 950. The transmission of oscillations from the handle 910 to the brush neck 920 is effected exclusively via the connecting element 950.

When the piezoelectric element 941 is electrically activated, a change in length of the piezoelectric element 941 occurs, whereby a bracket stroke of the spring brackets 942 and 943 in the X-direction (i.e. the longitudinal direction) of the toothbrush 900 is generated. This in turn leads to a displacement of the connecting element 950 and thus of the brush neck 920 with the U-brush 930 in the X-direction. In FIG. 12a, the piezoelectric element 941 is not activated; the brush neck 520 has (is located at) the smallest distance to the handle 910. FIG. 12b shows a depiction according to FIG. 12a at a second reversal point of this oscillation, wherein the brush neck 920 assumes (is located at) the greatest distance from the handle 910.

In summary, it can be stated that according to the present teachings a piezoelectric drive is provided, with which a change in length of a piezoelectric element is settable into a movement of a brush body, wherein the piezoelectric drive is characterized by particularly compact dimensions and at the same time relatively high torque.

1. A handle having a drive unit for a personal care appliance, the drive unit comprising:
a piezoelectric element extending in an X-direction and having a first longitudinal end and a second longitudinal end, the piezoelectric element being configured such that a change in length in the X-direction occurs upon electrical activation so that a distance between the first and second longitudinal ends in the X-direction changes,
a first spring bracket is attached to the piezoelectric element such that a first end of the spring bracket is fixed to the first longitudinal end of the piezoelectric element and a second end of the spring bracket is fixed to the second longitudinal end of the piezoelectric element, the first spring bracket being configured to convert the change in length of the piezoelectric element in the X-direction into a first bracket stroke in a Y-direction that is perpendicular to the X-direction, and
a connecting element attached to a central region of the spring bracket and configured to transmit the first bracket stroke.

2. The handle according to claim 1, further comprising a rotatable shaft connected to the connecting element such that the change in length of the piezoelectric element in the X-direction is converted into a rotational movement of the rotatable shaft.

3. A handle having a drive unit for personal care appliances, comprising:
a piezoelectric element configured to undergo a change in length in an X-direction upon electrical activation, and
a redirecting transmission configured to convert the change in length of the piezoelectric element in the X-direction into a rotational movement of a shaft for transmission to a brush head.

4. The handle according to claim 3, wherein the redirecting transmission comprises:
a first spring bracket configured to convert the change in length of the piezoelectric element in the X-direction into a first bracket stroke in a Y-direction that is perpendicular to the X-direction,
wherein the first spring bracket is connected to the shaft via a connecting element to convert the change of length of the piezoelectric element in the X-direction into rotation of the shaft.

5. The handle according to claim 2, wherein the connecting element is fixedly connected eccentrically to the rotatable shaft.

6. The handle according to claim 5, wherein the connecting element comprises a spring.

7. The handle according to claim 5, wherein the rotatable shaft comprises a pin segment configured to be inserted into an adapter of a brush head.

8. The handle according to claim 3, wherein the rotational movement of the shaft is an oscillatory movement at an oscillation frequency between 100 Hertz and 500 Hertz.

9. The handle according to claim 3, further comprising a switch configured to generate a linear oscillating movement in the X-direction of the shaft.

10.-16. (canceled)

17. A personal care appliance, comprising the handle according to claim 1 and a brush head attached to the handle and driven by the drive unit.

18. The personal care appliance according to claim 17, wherein:
the rotatable shaft comprises a pin segment configured to be inserted an adapter of the brush head, and
rotational oscillation of the rotatable shaft is transmittable to a brush of the brush head by the pin segment.

19. The personal care appliance according to claim 18, wherein an adapter of the brush head and the pin are designed such that, when the pin is inserted into the adapter, an anti-rotation lock and/or a fixation along an adapter axis is achieved.

20. The personal care appliance according to claim 19, wherein the fixation in the adapter axis is achieved by latching a latching lug of provided on the adapter in a groove defined in the pin.

21. The personal care appliance according to claim 19, wherein the anti-rotation lock comprises a lateral flattened portion defined on the pin and a conforming structure defined on the adapter.

22. The personal care appliance according to claim 20, wherein the pin has a flattened portion along its distal end, adjacent to the groove.

23. The personal care appliance according to claim 17, wherein:
the brush head comprises a brush neck,
the brush neck comprises in a distal region a cleaning element having an orientation axis, and in a proximal region, an adapter having an adapter axis,
the adapter is configured to connect the drive unit of the handle to the brush head, and
an angle formed by the adapter axis and the orientation axis is greater than 90°.

24. The personal care appliance according to claim 23, wherein the angle is from 91° to 120°.

25. The handle according to claim 2, wherein the rotatable shaft extends parallel to the X-direction.

26. A handle for a personal care appliance, comprising:
a piezoelectric element having a longitudinal axis extending in a first direction and having a first longitudinal end and a second longitudinal end, the piezoelectric element being configured such that a change in length in the first direction occurs upon energization of the piezoelectric element so that a distance between the first and second longitudinal ends changes in the first direction,
a spring bracket having a first end affixed to the first longitudinal end of the spring bracket and a second end affixed to the second longitudinal end of the piezoelectric element, the first spring bracket being configured to convert the change in length of the piezoelectric element in the first direction into a bracket stroke in a second direction that is perpendicular to the first direction, and
a connecting element attached to an intermediate region of the spring bracket between the first and second ends and configured to transmit the bracket stroke in the second direction.

27. The handle according to claim 26, wherein:
the piezoelectric element is planar and extends in a plane defined by the first direction and a third direction that is perpendicular to the first direction and to the second direction,
the spring bracket is a resilient band-shaped material,
the intermediate region of the spring bracket is spaced apart from the piezoelectric element at least when the piezoelectric element is not energized, and
the connecting element is affixed to a rotatable shaft that extends in parallel to the first direction.
